(19) United States
(12) Patent Application Publication
(10) Pub. No.: US 2004/0020838 A1
(43) Pub. Date: Feb. 5, 2004

(54) Filter or screen

(76) Inventors: Helmuth Gabl, Graz (AT); Christian Buedenbender, Graz (AT); Peter Sket, Gratkorn (AT)

Correspondence Address: ALIX YALE & RISTAS LLP, 750 MAIN STREET, SUITE 1400, HARTFORD, CT, 06103, US

(21) Appl. No.: 10/464,107

(22) Filed: Jun. 17, 2003

(30) Foreign Application Priority Data
Jun. 19, 2002 (AT) A 919/2002

(51) Int. Cl. B01D 29/41

(52) U.S. Cl. 210/232; 210/347

(57) ABSTRACT

A filter or screen for a membrane filter. The filter or screening discs being mounted on a hollow shaft made up of several shaft elements.

### BACKGROUND OF THE INVENTION

This invention relates generally to filter or screening discs for membrane filtration. More particularly, the present invention relates to filter or screening discs connected to a hollow shaft of the membrane filter.

Various types of filter are known with filter discs mounted on a hollow shaft. In particular, there are membrane filters that are used for crosscurrent filtration, e.g. according to WO 00/47312, where several discs are mounted on a shaft and several shafts of this type are mounted in such a way that the discs overlap. In these filters, the individual discs are pushed onto the hollow shaft. Discs were frequently broken, particularly in multi-shaft systems that are very difficult to install. In addition, it was necessary to dismantle the entire module (shaft with large number of discs) so that the discs to be repaired could be replaced. With the large number of disc elements, this work took quite some time, thus causing long machine downtimes.

### SUMMARY OF THE INVENTION

The aim of the invention is to create a system allowing simple installation and also easy repairs.

According to the invention, this is achieved by the hollow shaft being made up of several shaft elements. Thus, a shaft is created with a self-supporting function, which is simple to install and can also be repaired if necessary. In addition, the discs can also be pre-assembled on the shaft so that a precise connection is always guaranteed between the disc cavities with the drainage openings and the hollow part of the shaft for carrying off the permeate.

A favorable further development of the invention is characterized by one shaft element having one or several, preferably two to four, discs. This design permits simple and rapid erection of a complete hollow shaft, as well as disassembly for rapid repair. Furthermore, this design makes the shaft more stable.

If the individual shaft elements have a design that can be pieced together, they can be assembled quickly and also disassembled again rapidly.

The shaft elements can be manufactured from different materials. Similarly, a mixture of materials can be used, e.g. clamping fittings made of stainless steel, disc seat made of plastic.

If, according to the invention, the shaft elements are connected by a bayonet catch, the parts can be connected and also detached again without requiring excess force.

It is particularly useful if the torsional force is transferred by means of form closure, however it can also be transferred by frictional engagement as an alternative or in addition. This guarantees that the shaft elements are connected securely under any load occurring in the given application.

In order to guarantee that the liquid flows are safely separated, the invention foresees that sealing rings are provided between the individual shaft elements.

If additional shaft elements without filter discs (dummy segments) are provided between the shaft elements with filter or screening discs, the capacity of the filter can be adapted effectively to the given requirements, i.e. if a filter is to be extended at a later date, dummy elements are provided in the equipment delivered that can later be replaced by functional elements with filter or screening discs. Conversely, if the filtration capacity is to be reduced, e.g. if the medium has a different composition, an element with filter or screening discs can easily be replaced by a dummy element. As a result, the flow speeds into and onto the filter or screening discs remain the same and can always be set to the optimum.

### BRIEF DESCRIPTION OF THE DRAWINGS

The present invention may be better understood and its numerous objects and advantages will become apparent to those skilled in the art by reference to the accompanying drawings in which:

FIG. 1 is a section through a conventional filter;

FIG. 2 is a horizontal projection of a shaft element according to the invention;

FIG. 3 is a sectional view taken along line III-III of FIG. 2.

### DETAILED DESCRIPTION OF THE PREFERRED EMBODIMENT

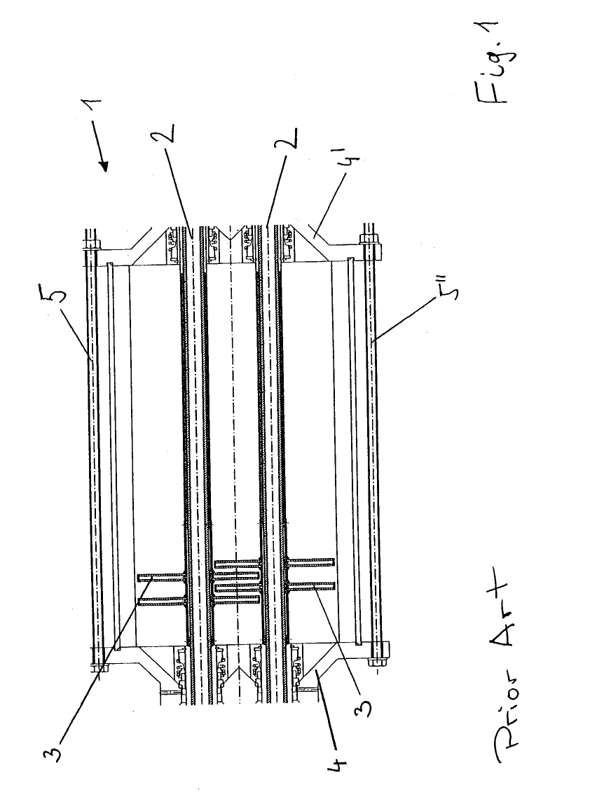

FIG. 1 shows a sectional view through a conventional filter 1, where two hollow shafts 2 are visible. To provide a clearer illustration, two filter discs 3 are shown here on each hollow shaft, although normally these discs 3 are fitted along the length of the entire shaft. This figure shows particularly clearly how the two end sections 4, 4′ have to be held together with several connecting rods 5, 5′. If a damaged filter disc is to be replaced, all of the connecting rods 5, 5′ and the hollow shafts 2 have to be completely dismantled. Afterwards the filter discs 3 that are still intact have to be taken off at one end until the damaged filter disc is reached and can then be replaced. Then the filter has to be re-assembled, which is a lengthy process.

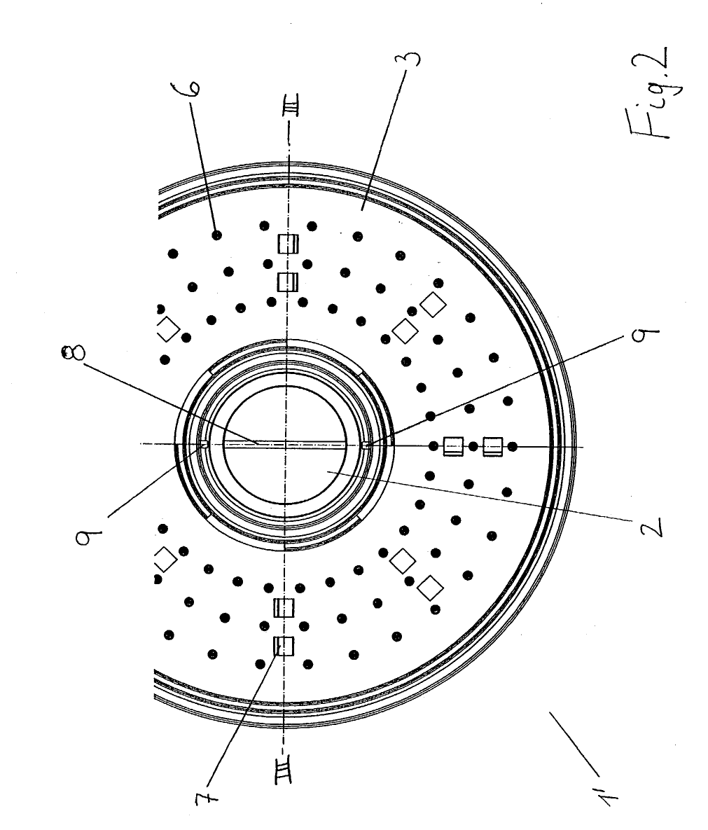

FIG. 2 shows a horizontal projection of a shaft element 1′ according to the invention, with a hollow shaft 2 and filter or screening discs 3. The filter or screening discs 3 can contain filter or screening surfaces of ceramic, metal or other materials, e.g. plastic. Depending on the application, perforations, pores or slot widths from <50 microns to several hundred microns up to approximately 2-5 mm can be used. The diameter of the hollow shaft 2 is selected according to the permeate mass flow, which results in significant differences in diameter when used as filtration or screening machine. The horizontal projection shows the fastening points 6 (welding points for example) of the filter or screening surface to the base frame of the filter or screening disc 3. The closing mechanism 7 for a filter or screening disc 3 with a two-part design is also shown. In addition, the illustration shows the bolt 8 with the parts 9 thereof extending beyond the body of the center shaft and through which the form closure, or connection, between the individual shaft elements 1′ is created as a bayonet catch.

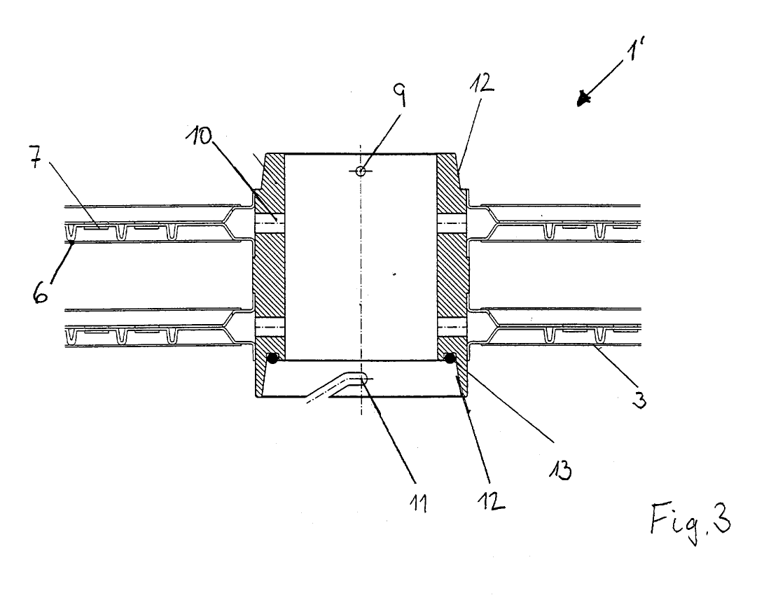

In FIG. 3, a sectional view is provided through shaft element 1′ according to the line marked III-III in FIG. 2. The shaft element 1′ shown has two filter discs 3, where one or more can be provided as required. Alternatively, shaft elements 1′ having no filter discs 3 attached (dummy elements) may also be used. For dummy elements, the discharge openings 10 normally provided in the cavity of the hollow shaft 2 can be omitted. Here the end of the bolt 9 at the top end is clearly shown. At the lower end there is a slot 11 of appropriate shape where the bolt end 9 locks into place during installation. Also shown here is the friction surface 12 at both the top and the bottom end of the shaft element 1′. Sealing rings 13 are provided to seal off the liquid flow between the shaft elements 1′. Depending on the application or also the length of the resulting filter shaft, it may be sufficient to provide a form closure only with bolts 8 and 9 and slot 11, or only one frictional engagement with the surfaces 12.

If additional shaft elements 1′ without filter discs (dummy elements) are provided between the shaft elements 1′ with filter or screening discs, 3 the capacity of the filter can be adapted effectively to the given requirements, i.e. if a filter is to be extended at a later date, dummy elements are provided in the equipment delivered that can later be replaced by functional elements with filter or screening discs. Conversely, if the filtration capacity is to be reduced, e.g. if the medium has a different composition, an element 1′ with filter or screening discs 3 can easily be replaced by a dummy element. As a result, the flow speeds into and onto the filter or screening discs remain the same and can always be set to the optimum.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. Filter or screen, for use with a membrane filter comprising:
a hollow shaft including a plurality of shaft elements and
a plurality of filter or screening discs mounted on the hollow shaft.

2. Filter or screen according to claim 1, wherein a one of the shaft elements has one filter or screening disc mounted thereon.

3. Filter or screen according to claim 1, wherein the shaft elements are removably connected together.

4. Filter or screen according to claim 1, wherein each of the shaft elements is connected to another of the shaft elements by a bayonet catch.

5. Filter or screen according to claim 4, wherein a torsional force imposed on a one of the shaft elements is transferred to each other shaft element by the bayonet catch connection.

6. Filter or screen according to claim 1, wherein a torsional force imposed on a one of the shaft elements is transferred to each other shaft element by frictional engagement.

7. Filter or screen according to claim 1, wherein the hollow shaft defines pairs of adjacent shaft elements and the filter or screen further comprises a plurality of sealing rings, a one of the sealing rings being disposed between the shaft elements of each pair of adjacent shaft elements.

8. Filter or screen according to claim 1, wherein at least one of the shaft elements has at least one filter or screening disc mounted thereon and at least one of the shaft elements has no filter or screening disc mounted thereon, a one of the shaft elements having no filter or screening disc mounted thereon being disposed adjacent to at least one of the shaft elements having at least one filter or screening disc mounted thereon.

9. Filter or screen according to claim 1, wherein a one of the shaft elements has a plurality of filter or screening discs mounted thereon.

10. Filter or screen according to claim 1, wherein a one of the shaft elements has two to four filter or screening discs mounted thereon.
